(19) United States
(12) Patent Application Publication
(10) Pub. No.: US 2018/0119622 A1
(43) Pub. Date: May 3, 2018

(54) METHOD AND SYSTEM FOR CONTROLLING ENGINE OPERATIONS

(71) Applicant: Electro-Motive Diesel, Inc., LaGrange, IL (US)

(72) Inventors: Adarsh Gopinathan Nair, Darien, IL (US); Sudarshan Loya, Naperville, IL (US)

(73) Assignee: Electro-Motive Diesel, Inc., LaGrange, IL (US)

(21) Appl. No.: 15/340,669

(22) Filed: Nov. 1, 2016

(51) Int. Cl. F02D 13/02; F02D 41/18; F02D 41/00; F02M 26/47; F01L 1/047; F02B 75/18

(52) U.S. Cl. CPC F02D 13/0226; F02D 41/18; F02D 41/0007; F02D 2250/34; F02M 26/47; F01L 1/047; F02B 75/18; F02D 41/0025

(57) ABSTRACT

A method for controlling engine operations, is provided herein. The engine includes at least a first bank having a first cylinder and a second cylinder associated with at least a turbocharger or an exhaust gas recirculation system. Each of the first and the second cylinder has a respective intake valve. The method determines an exhaust back pressure for each one of the first and the second cylinder. Further, the method determines an intake mass flow rate for each one of the first and the second cylinder based at least on the determined exhaust back pressure for the respective first and the second cylinder. The method adjusts a time duration of an open position of the respective intake valve for each one of the first and the second cylinder based on the determined intake mass flow rate for the corresponding first and the second cylinder.

### TECHNICAL FIELD

The present disclosure relates to a system and method for controlling engine operations. More particularly, the present disclosure relates to the method and system for controlling in-cylinder pressure and air-fuel ratio in various cylinders of the engine.

### BACKGROUND

A typical engine may comprise one or more cylinder banks that may further include one or more cylinders arranged along a length of the engine. For such engines, peak cylinder pressure (PCP), exhaust temperature and air-fuel ratio of each cylinder may vary from one end to the other end, for each engine bank. One of the main reasons for difference in PCP, exhaust temperature and air-fuel ratio is difference in fresh air intake mass flow rate between the cylinders. The difference in fresh air mass flow rate is caused by the distance of that cylinder from the common inlet point on the associated intake manifold; firing order and difference in exhaust back pressure due to cylinder position and exhaust manifold design. This means, greater is the distance of the cylinder from the common inlet point, lower is the amount and pressure of the intake fluid reaching that cylinder, and hence a lower intake mass flow rate for that cylinder.

The intake mass flow rate is also impacted by firing order of the engine. In case of an overlap between openings of intake valve between two cylinders on the same bank, the cylinder near to the common inlet point will draw in more air as compared to cylinder farther away. Further, in a turbocharged engine and/or an engine having an exhaust gas recirculation (EGR) system, an exhaust back pressure may increase on an exhaust port of each of the cylinders, as a distance of each of the cylinder increases from the turbocharger and/or the EGR system or the design of exhaust manifold for a particular cylinder due to space constraint or design of engine. The exhaust back pressure built up for each cylinder may result in further decrease on the intake mass flow rate and hence cause a decrease in the peak cylinder pressure and the air-fuel ratio for that cylinder while increasing the exhaust temperature of the engine. Usually, amongst the cylinders in a single bank, the cylinder positioned farthest from the turbocharger and/or the EGR system has the maximum exhaust back pressure which may result in minimum intake mass flow rate and the peak cylinder pressure for that cylinder.

Air-fuel ratio and the peak cylinder pressure variations amongst the various cylinders of the engine may adversely affect the engine performance. Additionally, the peak cylinder pressure variations may result in wear and tear of the associated cylinder and engine components.

US Patent Publication No. 2015/0075507 (hereinafter referred to as the '507 patent) relates to an engine control unit which executes a cylinder-by-cylinder air-fuel ratio control in which an air-fuel ratio of each of the cylinder is estimated based on a detection value of an air-fuel ratio sensor to adjust the air-fuel ratio of each cylinder.

### SUMMARY

According to one aspect of the present disclosure, a method for controlling engine operations is provided. The engine includes at least a first bank having a first cylinder and a second cylinder associated with at least a turbocharger or an exhaust gas recirculation system. Each of the first and the second cylinder has a respective intake valve. The method determines an exhaust back pressure for each one of the first and the second cylinder. Further, the method determines an intake mass flow rate for each one of the first and the second cylinder based at least on the determined exhaust back pressure for the respective first and the second cylinder. The method adjusts a time duration of an open position of the respective intake valve for each one of the first and the second cylinder based on the determined intake mass flow rate for the corresponding first and the second cylinder.

According to another aspect of the present disclosure, an engine system is provided. The engine system includes a first bank having a first cylinder and a second cylinder, each of the first and the second cylinder having a respective intake valve. The engine system further includes at least one of a turbocharger or an EGR system associated with the first and the second cylinder. Furthermore, the engine system includes at least one camshaft associated with each of the first and the second cylinder, the camshaft having a plurality of intake cam lobes associated with and configured to control opening and closing of the respective intake valves of the first and the second cylinder. The intake cam lobes are timed individually for each one of the first and the second cylinder in order to adjust the time duration of an open position of the respective intake valve of each of the first and the second cylinder.

### BRIEF DESCRIPTION OF THE DRAWINGS

FIG. 1 illustrates schematic representation of an exemplary engine system;

FIG. 2 illustrates an exemplary cylinder of an engine in the engine system;

FIG. 3 illustrates different time durations of open position for intake valves corresponding to two cylinders in a bank of the engine; and

FIG. 4 illustrates an exemplary method for controlling engine operations.

### DETAILED DESCRIPTION

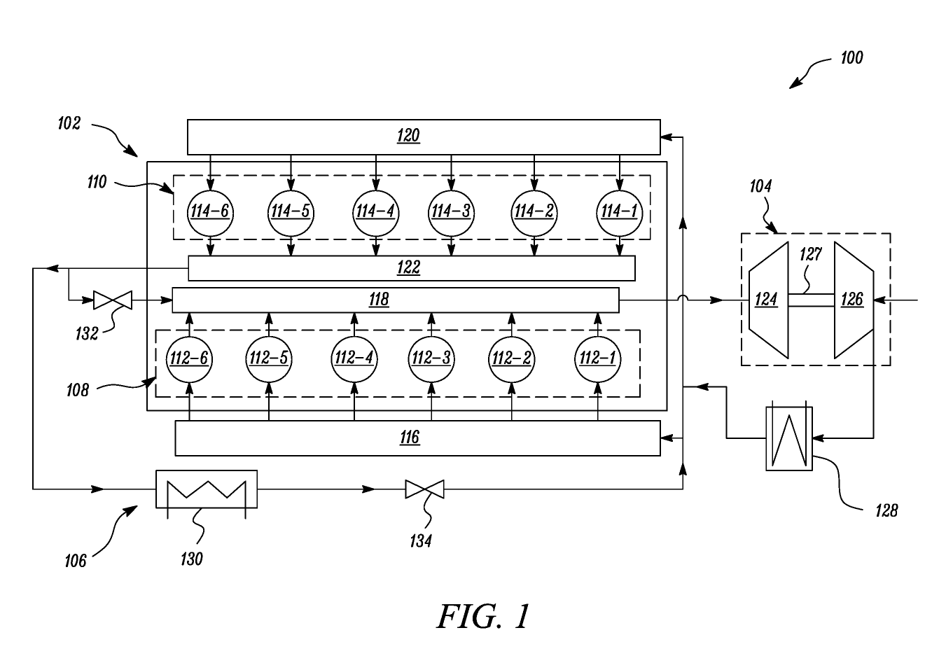

The present disclosure relates to a system and method for controlling engine operations. FIG. 1 illustrates a schematic representation of an exemplary engine system 100 for a machine (not shown). As illustrated, the engine system 100 includes an engine 102, and a turbocharger 104 and an exhaust gas recirculation system 106 associated with the engine 102.

The engine 102 may be based on one of the commonly applied power-generation units, such as an internal combustion engine (ICE). In an embodiment, the engine 102 is a multi-cylinder engine. The engine 102 may include a V-type engine, in-line engine, or an engine with different configurations, as is conventionally known. Although not limited, the engine 102 may be a spark-ignition engine or a compression ignition engine, which may be applied in construction machines or locomotives.

In an embodiment of the present disclosure, the engine 102 includes a plurality of cylinders arranged in V-type configuration of two engine banks, such as first engine bank 108, and second engine bank 110. The first engine bank 108 includes a first set of cylinders, such as cylinders 112-1, 112-2, 112-3 . . . 112-6, hereinafter collectively referred to as the first set of cylinders 112. Similarly, the second engine bank 110 includes a second set of cylinders, such as cylinders 114-1, 114-2, 114-3 . . . 114-6, hereinafter collectively referred to as the second set of cylinders 114. It may be contemplated that the number of banks and cylinders in the engine 102 are merely exemplary and may be varied without deviating from the scope of the claimed subject matter.

The engine 102 further includes a first intake manifold 116 and a first exhaust manifold 118 associated with the first set of cylinders 112 and a second intake manifold 120 and a second exhaust manifold 122 associated with the second set of cylinders 114. The intake manifolds 116, 120 are configured to provide fluid, such as air and/or air/fuel mixture to the first set of cylinders 112 and the second set of cylinders 114, respectively. The exhaust manifolds 118, 122 are configured to receive exhaust fluids, for example, exhaust gases, from the first set of cylinders 112 and the second set of cylinders 114, respectively. FIG. 1 shows that the intake manifold 116, 120 and the exhaust manifolds 118, 122 are multi-part constructions for the sake of simplicity. However, it may be contemplated that any other configuration and construction of the intake and the exhaust manifolds may be realized without deviating from the scope of the claimed subject matter.

In an embodiment of the present disclosure, the turbocharger 104 is associated with at least one set of cylinders, such as the first set of cylinders 112. The turbocharger 104 includes a turbine 124 and a compressor 126. The turbine 124 is fluidly connected to the first exhaust manifold 118 and is driven by the exhaust gases generated by the first set of cylinders 112. The turbine 124 may include a turbine wheel carried by a shaft 127 which is rotatably mounted within a housing. A variable nozzle valve (not shown) may be placed in the fluid flow path from the first exhaust manifold 118 to the turbine 124 to control the velocity of the exhaust gases impinging on the turbine wheel of the turbine 124.

The compressor 126 may include a compressor wheel carried by the shaft 127 connected to the turbine wheel of the turbine 124. Thus, the rotation of the turbine wheel in turn rotates the compressor wheel to drive the compressor 126. The compressor 126 is configured to compress air and provide high pressure compressed air to the intake manifolds 116 and 120. An aftercooler 128 may be provided between the compressor 126 and the intake manifolds 116, 120. The aftercooler 128 is configured to extract heat from the compressed air coming from the compressor 126 in order to decrease the temperature and increase the density of the air provided to the intake manifolds 116, 120. FIG. 1 shows a single turbocharger 104, however, multiple stage turbochargers, superchargers, etc., may also be realized without deviating from the scope of the claimed subject matter.

In an embodiment of the present disclosure, the engine system 100 includes the EGR system 106 associated with at least one set of cylinders, such as the second set of cylinders 114. The second set of cylinders 114 act as donor cylinders to provide exhaust gases to the EGR system 106 for recirculation in the engine 102. The EGR system 106 includes an EGR cooler 130 fluidly connected to the second exhaust manifold 122. The EGR cooler 130 is configured to receive at least a portion of exhaust gases from the second exhaust manifold 122 and extract heat from the exhaust gases before recirculating to the first intake manifold 116 and the second intake manifold 120. An exhaust restriction valve 132 may be provided between the second exhaust manifold 122 and the EGR cooler 130. The exhaust restriction valve 132 may be configured to selectively provide some portion of the exhaust gases from the second exhaust manifold 122 to the first exhaust manifold 118 and further to the turbine 124 of the turbocharger 104.

Further, the EGR system 106 includes an EGR control valve 134 provided downstream of the EGR cooler 130 to regulate the exhaust gas recirculation into the first and the second intake manifolds 116, 120.

The turbocharger 104 and the EGR system 106 are implemented as known conventionally, hence, their detailed working is not included herein for the sake of brevity of the present disclosure.

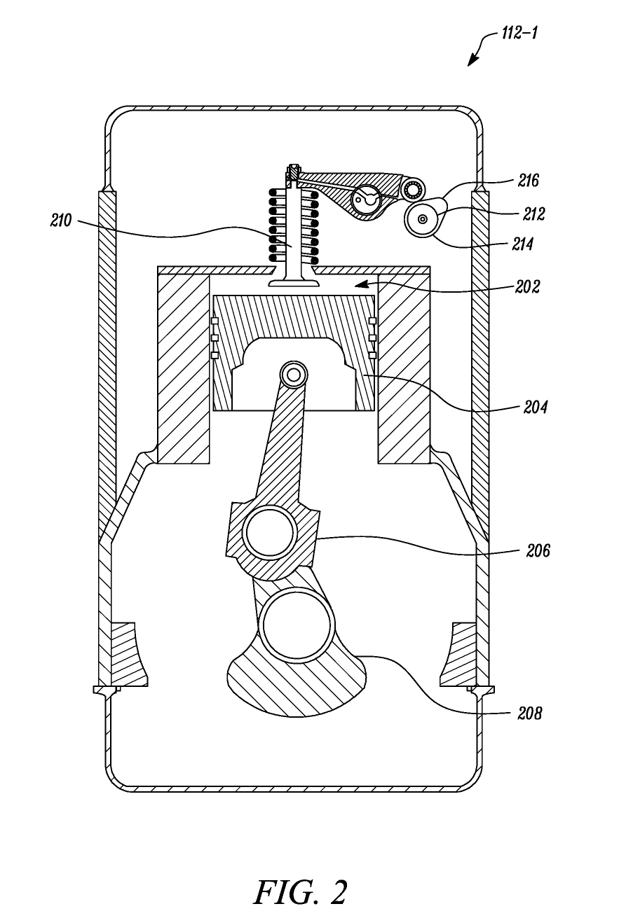

FIG. 2 illustrates an exemplary cylinder, such as cylinder 112-1. It may be well contemplated that the cylinder 112-1, as shown in FIG. 2 may be implemented in each of the first set of cylinders 112 and the second set of cylinders 114 having respective similar components as that shown in FIG. 2. The cylinder 112-1 includes a combustion chamber 202, a piston 204, a connecting rod 206 coupled to the piston 204, and a crankshaft 208 rotatably coupled to the connecting rod 206, as is customary. A sliding (or reciprocal) motion of the piston 204 during a power stroke of the engine 102 results in a rotation of the crankshaft 208. Further, the movement of the piston 204 facilitates removal of the combustion gases from the combustion chamber through the exhaust valve.

The cylinder 112-1 includes at least one intake valve 210 and at least one exhaust valve (not shown), each opening to the combustion chamber 202. A camshaft 212 carrying a cam 214 having one or more intake cam lobes 216 may be arranged to operate the intake valve 210. The intake valve 210 is operated cyclically based on the configuration of the cam 214, the intake cam lobe 216 and the rotation of the camshaft 212 to achieve desired intake valve timing T, as is customary. In an embodiment of the present disclosure, the intake cam lobe 216 may be configured to operate the intake valve 210 to be in an open position for a time duration TD to provide fluid flow into the cylinder 112-1 from the first intake manifold 116. The exhaust valve is also operated in a similar manner by a respective cam and lobe provided on the camshaft 212, to achieve desired exhaust valve timing. The exhaust valve may be in the open position to facilitate exhaust gases to flow out of the cylinder 112-1 into the first exhaust manifold 118.

It may be contemplated that the cylinder 112-1 shown in FIG. 2 is merely exemplary and may be varied to achieve similar results, without deviating from the scope of the claimed subject matter.

In an embodiment of the present disclosure, the intake cam lobe 216 is timed individually for each of the cylinders in the first set of cylinders 112 and the second set of cylinders 114, to individually adjust the time duration TD of the open position of the respective intake valves corresponding to each of the cylinders. In an exemplary embodiment, the time duration TD of the open position of the intake valve 210 is based on the intake mass flow rate of the respective cylinder, such as cylinder 112-1.

The intake mass flow rate for the cylinder is defined as the amount of intake fluid pushed inside the cylinder 112-1. The intake mass flow rate of the cylinder 112-1 may be determined based on a distance the intake fluid travels from a common inlet point in the intake manifolds 116, 120 to reach the cylinder 112-1. Therefore, farther a cylinder is from the common inlet point in the intake manifold 116, 120, greater is the distance that the intake fluid has to travel to reach that cylinder. Consequently, lesser is the pressure of the intake fluid reaching that cylinder, which further results in lesser intake mass flow rate for that cylinder.

The intake mass flow rate is further varied because of an exhaust back pressure built up on the exhaust valve of each of the cylinders in the first set of cylinders 112 and the second set of cylinders 114. For example, the exhaust back pressure increases residual gases inside the cylinder at higher pressure. This provides a restriction to the entrance of the intake fluid into that cylinder, thereby decreasing the intake mass flow rate for that cylinder. The exhaust back pressure is built up on each of the cylinders in the first set of cylinders 112 and the second set of cylinders 114 based on a distance of the respective cylinder from either the turbocharger 104 and/or the EGR system 106. The distance of a cylinder is measured as a distance that the exhaust fluid travels from the respective cylinder to reach the turbocharger 104 and/or the EGR cooler 130. Therefore, farther a cylinder is from the turbocharger 104 and/or the EGR cooler 130, greater is the distance that the exhaust fluid has to travel from that cylinder and hence, greater is the exhaust back pressure on that cylinder. For example, for the first set of cylinders 112, the exhaust back pressure on a cylinder is based on the distance of that cylinder from the turbocharger 104. Similarly, for the second set of cylinders 114, the exhaust back pressure on a cylinder is based on the distance of that cylinder from the EGR system 106.

Further, as shown in FIG. 1, since the cylinder 112-6 is farthest from the common inlet of the intake manifold 116, the pressure of the intake fluid reaching the cylinder 112-6 is the least in the first set of cylinders 112, and the exhaust back pressure is the highest. Thus, the exhaust back pressure on the cylinder 112-6 further decreases the intake mass flow rate for the cylinder 112-6. Therefore, the intake mass flow rate for the cylinder 112-6 is least in the first set of cylinders 112.

For the second set of cylinders 114, the exhaust back pressure on the cylinder 114-1 is the highest because it is positioned farthest from the EGR cooler 130. Whereas, the distance of the cylinder 114-1 is the smallest from the common inlet point in the second intake manifold 120. However, in the second set of cylinders 114, the cylinder 114-5 may have a lower exhaust back pressure as compared to the cylinder 114-1, but a lower pressure of intake fluid as compared to that of cylinder 114-1. Therefore, the intake mass flow rate of the cylinder 114-1 and the cylinder 114-5 will be different from each other.

In an embodiment of the present disclosure, the intake mass flow rate for each cylinder in the first set of cylinders 112 and the second set of cylinders 114 is also based on a firing order defined for the engine 102. The firing order determines the opening position of the intake and exhaust valves. In case of overlap between opening position of two intake valves on the same bank, the cylinder which is near to the common inlet point will receive more fresh air as compared to the cylinder away.

In an exemplary embodiment of the present disclosure, the time duration TD of an open position of the intake valve of each of the cylinders, in the first set of cylinders 112 and the second set of cylinders 114, is adjusted based on the intake mass flow rate of the respective cylinder. In order to bring the intake mass flow rate of each of the cylinders in the engine 102 close to each other, the time duration TD of the open position of intake valves of the respective cylinders are adjusted based on the intake mass flow rate of the respective cylinders. In an embodiment of the present disclosure, as the intake mass flow rate for each of the cylinder decreases, the time duration TD of the open position of the intake valve of the respective cylinders increases.

According to an exemplary embodiment, the time duration TD of the open position of the intake valves of the cylinders 112, 114 are adjusted by individually timing the intake cam lobes 216 associated with the respective intake valves. In one embodiment, the intake cam lobes 216 are timed at the time of manufacturing by taking experimental data for the exhaust back pressure, the firing order of the engine 102 and the intake mass flow rate corresponding to each of the cylinders in the first set of cylinders 112 and the second set of cylinders 114. In an alternative embodiment, the exhaust back pressure and intake mass flow rate for each cylinder may be monitored automatically, for example by an engine controller, and the intake cam lobes 216 are adjusted automatically and dynamically based on the dynamically determined intake mass flow rate. In this embodiment, the intake cam lobes 216 may be automatically adjusted by using cam phasor arrangements.

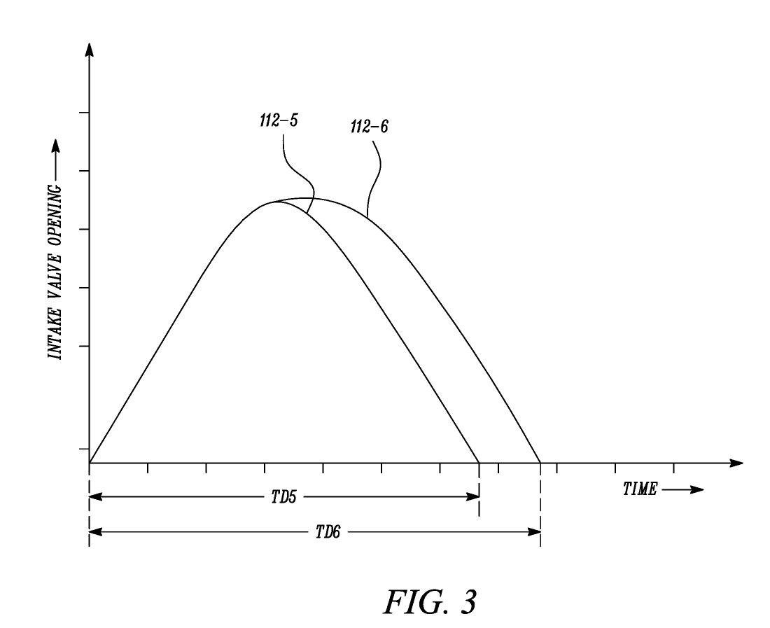

In an embodiment of the present disclosure, consider an exemplary set of two cylinders, such as cylinders 112-5 and 112-6, in the first bank 108 of the engine 102, as shown in FIG. 1. Amongst the two cylinders 112-5 and 112-6, the cylinder 112-6 is positioned at a greater distance from the turbocharger 104 than the cylinder 112-5. Therefore, the intake mass flow rate of the cylinder 112-6 is less than that of the cylinder 112-5. Therefore, the time duration TD6 of the open position of intake valve corresponding to the cylinder 112-6 is greater than the time duration TD5 of the open position of the intake valve 210-5 corresponding to the cylinder 112-5, as shown in FIG. 3.

In another embodiment, consider an exemplary set of two cylinders, such as cylinders 114-3 and 114-4 in the second bank 110 of the engine 102, as shown in FIG. 1. Amongst the two cylinders 114-3 and 114-4, the cylinder 114-3 has a higher exhaust back pressure than the cylinder 114-4. However, the intake fluid pressure at the cylinder 114-3 is greater than that of the cylinder 114-4. Furthermore, in an exemplary scenario, the firing order of the engine 102 defines the firing of cylinder 114-3 overlapping for some time with cylinder 114-4. Therefore, the intake valve of the cylinder 114-3 opens simultaneously with 114-4, resulting in an increase in the intake mass flow rate for the cylinder 114-3. Therefore, in this scenario, even though the exhaust back pressure on cylinder 114-3 is higher than that on the cylinder 114-4, the firing order of the engine 102 results in an increase of the intake mass flow rate for the cylinder 114-3. Consequently, the intake mass flow rate of cylinder 114-3 is greater than that of cylinder 114-4. Therefore, the time duration TD of the open position of the intake valve corresponding to the cylinder 114-4 is greater than that of the cylinder 114-3.

The intake cam lobes 216 corresponding to each of the cylinders in the first set of cylinders 112 and the second set of cylinders 114 are timed individually to achieve the desired time duration TD of the open position of the intake valve of the corresponding cylinder.

### INDUSTRIAL APPLICABILITY

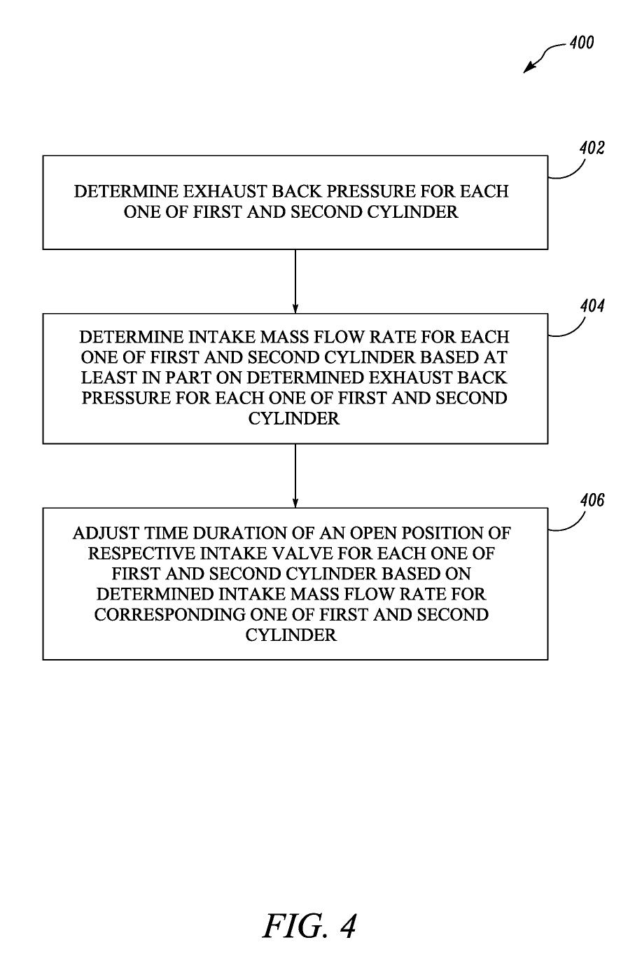

FIG. 4 illustrates an exemplary method 400 for controlling operations of the engine 102. In an embodiment of the present disclosure, the method 400 is performed at the time of manufacturing the engine system 100. In an alternative embodiment of the present disclosure, the method 400 may be performed dynamically by an engine controller associated with the engine system 100.

The following description of method 400 is described for the engine 102 having at least one engine bank having two cylinders. However, the description may be extended to any type of engine having any number of engine banks and each of the engine bank having two or more cylinders. In an embodiment of the present disclosure, the engine 102 has a first engine bank 108 having a first cylinder, for example, 112-5 and a second cylinder, for example, cylinder 112-6. Each of the first and the second cylinders 112-5 and 112-6 are associated with the turbocharger 104.

At step 402, exhaust back pressure on each of the first cylinder 112-5 and the second cylinder 112-6 is determined. The exhaust back pressure is built up on each of the cylinders 112-5 and 112-6 based on a distance of the respective cylinder from the turbocharger 104.

At step 404, an intake mass flow rate for each one of the first cylinder 112-5 and the second cylinder 112-6 is determined. In an embodiment of the present disclosure, the intake mass flow rate for each one of the first cylinder 112-5 and the second cylinder 112-6 is based on the determined exhaust back pressure for the respective first cylinder 112-5 and the second cylinder 112-6. As shown in FIG. 1, amongst the two cylinders 112-5 and 112-6, the second cylinder 112-6 is positioned at a greater distance from the turbocharger 104 than the first cylinder 112-5. Therefore, the intake mass flow rate of the cylinder 112-6 is less than that of the cylinder 112-5. In a further embodiment of the present disclosure, the intake mass flow rate for each of the first cylinder 112-5 and the second cylinder 112-6 may also be based on a firing order of the engine 102.

Further, at step 406, a time duration of an open position of the respective intake valves for each of the first cylinder 112-5 and the second cylinder 112-6 is adjusted based on the determined intake mass flow rate for the corresponding first cylinder 112-5 and the second cylinder 112-6. In an embodiment of the present disclosure, the time duration TD6 of the open position of the intake valve corresponding to the second cylinder 112-6 is greater than the time duration TD5 of the open position of the intake valve corresponding to the first cylinder 112-5, as shown in FIG. 3.

The method 400 may be applied to all the banks of the engine 102, such that all the cylinders in the bank may be defined into pairs having the first cylinder and the second cylinder in order to achieve the desired time duration TD of the open position of the respective intake valve based on the determined intake mass flow rate for the respective cylinders.

The engine system 100 and the method 400 of the present disclosure facilitate compensating the deficiency of the intake mass flow rate in each cylinder in order to achieve minimal peak cylinder pressure (PCP) and air-to fuel ratio variations amongst the various cylinders in an engine. Therefore, if a cylinder is receiving decreased intake mass flow rate, their respective intake cam lobes may be positioned so that the respective intake valve of that cylinder is open for a longer duration. The longer duration of intake valve opening allows more intake fluid to be received by the cylinder, thereby increasing the intake mass flow rate and hence compensating for the deficiency in the intake mass flow rate caused due to the exhaust back pressure on that cylinder.

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the art that this disclosure can also be employed in a variety of other applications. Thus, the detailed description herein is presented for purposes of illustration only and not of limitation.

It may be further noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A method for controlling engine operation, the engine having at least a first bank having a first cylinder and a second cylinder associated with at least one of a turbocharger or an exhaust gas recirculation (EGR) system, each of the first and the second cylinder having a respective intake valve, the method comprising:
determining an exhaust back pressure for each one of the first and the second cylinder;
determining an intake mass flow rate for each one of the first and the second cylinder based at least in part on the determined exhaust back pressure for each one of the first and the second cylinder; and
adjusting a time duration of an open position of the respective intake valve for each one of the first and the second cylinder based on the determined intake mass flow rate for corresponding first and the second cylinder.

2. The method as claimed in claim 1, wherein the exhaust back pressure for each of the first and the second cylinder is based on a distance of each of the first and the second cylinder from the at least one of the turbocharger or the EGR system.

3. The method as claimed in claim 2, wherein a distance of the second cylinder from the at least one of the turbocharger or the EGR system is greater than a distance of the first cylinder from the at least one of the turbocharger or the EGR system.

4. The method as claimed in claim 3, wherein the exhaust back pressure for the second cylinder is greater than the determined exhaust back pressure for the first cylinder.

5. The method as claimed in claim 1, wherein the intake mass flow rate for each one of the first and the second cylinder is further based on a firing order of engine.

6. The method as claimed in claim 1, wherein the intake mass flow rate for each one of the first and the second cylinder is based on a distance of each of the first and the second cylinder from a common inlet point of intake fluid in an intake manifold associated with the first and the second cylinder.

7. The method as claimed in claim 1, wherein adjusting the time duration of the open position further comprising increasing the time duration of open position of the respective intake valve as the intake mass flow rate decreases for each of the first and the second cylinder.

8. An engine system comprising:
at least a first bank having a first cylinder and a second cylinder, each one of the first and the second cylinder having a respective intake valve;
at least one of a turbocharger or an exhaust gas recirculation (EGR) system associated with the first and the second cylinder; and
at least one camshaft associated with each of the first and second cylinder, the cam shaft including a plurality of intake cam lobes associated with and configured to control opening and closing of the respective intake valves of the first and the second cylinder,
wherein the intake cam lobes are timed individually, for each one of the first and second cylinder, to adjust a time duration of an open position of the respective intake valve corresponding to each one of the first and the second cylinder.

9. The engine system as claimed in claim 8, wherein the intake cam lobes are timed based on an intake mass flow rate of each one of the first and the second cylinder.

10. The engine system as claimed in claim 9, wherein the intake mass flow rate of each of the first and the second cylinder is based on a firing order of the engine.

11. The engine system as claimed in claim 9, wherein the intake mass flow rate for each one of the first and the second cylinder is based on a distance of each of the first and the second cylinder from a common inlet point of intake fluid in an intake manifold associated with the first and the second cylinder.

12. The engine system as claimed in claim 9, wherein the intake mass flow rate of each of the first and the second cylinder is based on an exhaust back pressure associated with each of the first and the second cylinder.

13. The engine system as claimed in claim 12, wherein the exhaust back pressure for each one of the first and the second cylinder is based on a distance of each of the first and the second cylinder from the at least one of the turbocharger or the EGR system.

14. The engine system as claimed in claim 13, wherein a distance of the second cylinder from the at least one of the turbocharger or the EGR system is greater than a distance of the first cylinder from the at least one of the turbocharger or the EGR system.

15. The engine system as claimed in claim 14, wherein the exhaust back pressure for the second cylinder is greater than the exhaust back pressure for the first cylinder.

16. The engine system as claimed in claim 9, wherein the time duration of the open position of the respective intake valves increases as the intake mass flow rate decreases for each of the first and the second cylinder.
